(19) United States
(12) Patent Application Publication
(10) Pub. No.: US 2011/0148926 A1
(43) Pub. Date: Jun. 23, 2011

(54) IMAGE DISPLAY APPARATUS AND METHOD FOR OPERATING THE IMAGE DISPLAY APPARATUS

(75) Inventors: Sangjun KOO, Seoul (KR); Kyunghee YOO, Seoul (KR); Hyungnam LEE, Seoul (KR); Saehun JANG, Seoul (KR); Sayoon HONG, Seoul (KR); Uniyoung KIM, Seoul (KR)

(73) Assignee: LG Electronics Inc.

(21) Appl. No.: 12/902,799

(22) Filed: Oct. 12, 2010

(30) Foreign Application Priority Data
Dec. 17, 2009 (KR) 10-2009-0126347

(51) Int. Cl. G09G 5/00; G06F 3/033; G06F 3/048

(52) U.S. Cl. 345/635; 345/156; 345/157; 715/810; 715/803

(57) ABSTRACT

A method for operating an image display apparatus is provided that includes sensing a height or eye height of a user, dividing a screen of a display into an input window and an output window corresponding to the sensed height or eye height of the user, receiving an input on the input window, and displaying an image to correspond to the received input.

This application claims priority from Korean Patent Application No. 10-2009-0126347, filed on Dec. 17, 2009, the subject matter of which is hereby incorporated by reference.

### BACKGROUND

1. Field

Embodiments may relate to an image display apparatus and a method for operating the image display apparatus.

2. Background

An image display apparatus may display images viewable to a user. The image display apparatus may display a broadcasting program selected by the user on a display from among a plurality of broadcasting programs transmitted from broadcasting stations. A trend in broadcasting is a shift from analog broadcasting to digital broadcasting.

Digital broadcasting may offer advantages over analog broadcasting such as robustness against noise, less data loss, ease of error correction, and/or an ability to provide high-definition, clear images. Digital broadcasting may also allow interactive services for viewers.

As the image display apparatus is equipped with more functions and various contents are available to the image display apparatus, methods may be provided for optimizing screen layout and screen division in order to efficiently utilize functions and contents.

### BRIEF DESCRIPTION OF THE DRAWINGS

Arrangements and embodiments may be described in detail with reference to the following drawings in which like reference numerals refer to like elements and wherein:

FIG. 1 is a block diagram of an image display apparatus according to an exemplary embodiment of the present invention;

FIG. 2 is a block diagram of a controller illustrated in FIG. 1;

FIGS. 3a and 3b are diagrams illustrating a remote controller illustrated in FIG. 1;

FIG. 4 is a block diagram of part of an interface (illustrated in FIG. 1) and a pointing device (illustrated in FIGS. 3a and 3b);

FIG. 5 is a view illustrating an example of pivoting an image display apparatus;

FIG. 6 is a flowchart illustrating a method for operating the image display apparatus according to an exemplary embodiment of the present invention; and

FIGS. 7 to 12 are views relating to describing a method for operating the image display apparatus as shown in FIG. 6.

### DETAILED DESCRIPTION

Exemplary arrangements and embodiments of the present invention may be described below with reference to the attached drawings.

The terms “module” and “portion” attached to describe names of components may be used herein to help an understanding of the components and thus should not be considered as having specific meanings or roles. Accordingly, the terms “module” and “portion” may be interchangeable in their use.

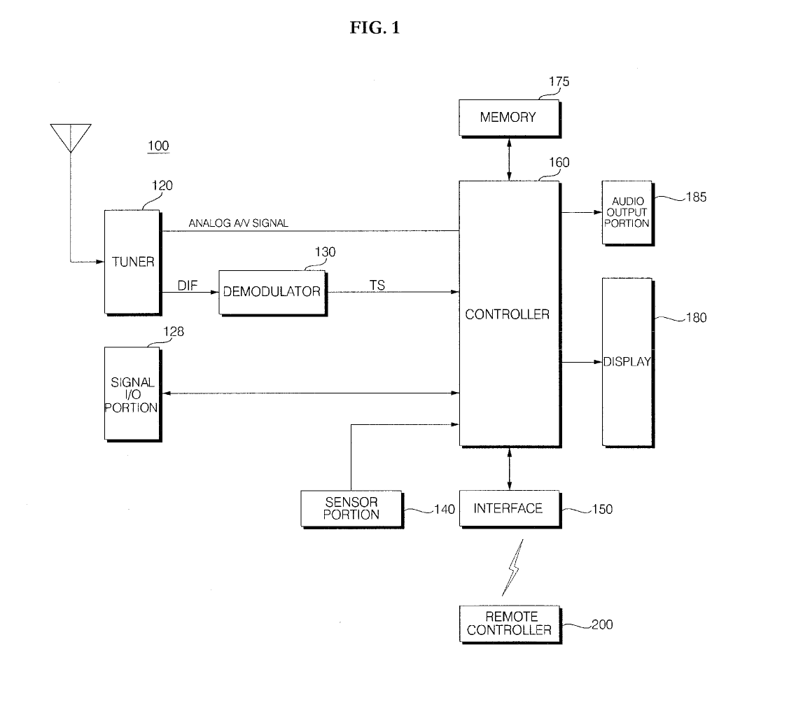

FIG. 1 is a block diagram of an image display apparatus according to an exemplary embodiment of the present invention. Other embodiments and configuration may also be provided.

As shown in FIG. 1, an image display apparatus 100 may include a tuner 120, a signal Input/Output (I/O) portion 128, a demodulator 130, a sensor portion 140, an interface 150, a controller 160, a storage 175 (or memory), a display 180, and an audio output portion 185.

The tuner 120 may select a Radio Frequency (RF) broadcast signal corresponding to a channel selected by a user from among a plurality of RF broadcast signals received through an antenna and downconvert the selected RF broadcast signal to a digital Intermediate Frequency (IF) signal or an analog baseband Audio/Video (A/V) signal. More specifically, if the selected RF broadcast signal is a digital broadcast signal, the tuner 120 may downconvert the selected RF broadcast signal to a digital IF signal, DIF. On the other hand, if the selected RF broadcast signal is an analog broadcast signal, the tuner 120 may downconvert the selected RF broadcast signal to an analog baseband A/V signal, CVBS/SIF. That is, the tuner 120 may be a hybrid tuner capable of processing not only digital broadcast signals but also analog broadcast signals. The analog baseband A/V signal CVBS/SIF may be directly input to the controller 160.

The tuner 120 may receive RF broadcast signals from an Advanced Television Systems Committee (ATSC) single-carrier system or from a Digital Video Broadcasting (DVB) multi-carrier system, as may be described below.

While FIG. 1 shows the single tuner 120, two or more tuners may be used in the image display apparatus 100. In using two or more tuners, aside from the RF broadcast signal received through the tuner 120, a second tuner (not shown) may sequentially or periodically receive a number of RF broadcast signals corresponding to a number of broadcast channels preliminarily memorized (or stored) in the image display apparatus 100. The second tuner, like the tuner 120, may downconvert a received digital RF broadcast signal to a digital IF signal or a received analog broadcast signal to a baseband A/V signal, CUBS/SIF.

The demodulator 130 may receive the digital IF signal DIF from the tuner 120 and demodulate the digital IF signal DIF1.

For example, if the digital IF signal DIF is an ATSC signal, the demodulator 130 may perform 8-Vestigal SideBand (VSB) demodulation on the digital IF signal DIF 1. The demodulator 130 may also perform channel decoding. For the channel decoding, the demodulator 130 may include a Trellis decoder (not shown), a deinterleaver (not shown) and/or a Reed-Solomon decoder (not shown) and perform Trellis decoding, deinterleaving and Reed-Solomon decoding.

For example, if the digital IF signal DIF is a DVB signal, the demodulator 130 may perform Coded Orthogonal Frequency Division Multiple Access (COFDMA) demodulation on the digital IF signal DIF. The demodulator 130 may also perform channel decoding. For the channel decoding, the demodulator 130 may include a convolution decoder (not shown), a deinterleaver (not shown), and/or a Reed-Solomon decoder (not shown) and perform convolution decoding, deinterleaving, and Reed-Solomon decoding.

The signal I/O portion 128 may transmit signals to and/or receive signals from an external device. For signal transmission to and reception from the external device, the signal I/O portion 128 may include an A/V I/O portion (not shown) and a wireless communication module (not shown).

The signal I/O portion 128 may be coupled to an external device such as a Digital Versatile Disc (DVD), a Bluray disc, a gaming device, a camcorder, and/or a computer (e.g., a laptop computer). The signal I/O portion 128 may externally receive video, audio, and/or data signals from the external device and transmit the received external input signals to the controller 160. The signal I/O portion 128 may output video, audio, and/or data signals processed by the controller 160 to the external device.

In order to receive or transmit A/V signals from or to the external device, the A/V I/O portion of the signal I/O portion 128 may include an Ethernet port, a Universal Serial Bus (USB) port, a Composite Video Banking Sync (CVBS) port, a component port, a Super-video (S-video) (analog) port, a Digital Visual Interface (DVI) port, a High-Definition Multimedia Interface (HDMI) port, a Red-Green-Blue (RGB) port, a D-sub port, an Institute of Electrical and Electronics Engineers (IEEE)-1394 port, a Sony/Philips Digital Interconnect Format (S/PDIF) port, and/or a LiquidHD port.

Various digital signals received through various ports may be input to the controller 160. On the other hand, analog signals received through the CVBS port and the S-video port may be input to the controller 160 and/or may be converted to digital signals by an Analog-to-Digital (A/D) converter (not shown).

The wireless communication module of the signal I/O portion 128 may wirelessly access the Internet. For the wireless Internet access, the wireless communication module may use a Wireless Local Area Network (WLAN) (i.e., Wi-Fi), Wireless Broadband (Wibro), World Interoperability for Microwave Access (WiMax), and/or High Speed Downlink Packet Access (HSDPA).

In addition, the wireless communication module may perform short-range wireless communication with other electronic devices. For short-range wireless communication, the wireless communication module may use Bluetooth, Radio-Frequency IDentification (RFID), Infrared Data Association (IrDA), Ultra WideBand (UWB), and/or ZigBee.

The signal I/O portion 128 may be coupled to various set-top boxes through at least one of the Ethernet port, the USB port, the CVBS port, the component port, the S-video port, the DVI port, the HDMI port, the RGB port, the D-sub port, the IEEE-1394 port, the S/PDIF port, and the Liquid HD port and may thus receive data from or transmit data to the various set-top boxes. For example, when coupled to an Internet Protocol Television (IPTV) set-top box, the signal I/O portion 128 may transmit video, audio and/or data signals processed by the IPTV set-top box to the controller 160 and may transmit various signals received from the controller 160 to the IPTV set-top box.

The term ‘IPTV’ may cover a broad range of services depending on transmission networks, such as Asymmetric Digital Subscriber Line-TV (ADSL-TV), Very high speed Digital Subscriber Line-TV (VDSL-TV), Fiber To The Home-TV (FTTH-TV), TV over DSL, Video over DSL, TV over IP (TVIP), Broadband TV (BTV), and/or Internet TV and full-browsing TV, which may be capable of providing Internet-access services.

The image display apparatus 100 may access the Internet or communicate over the Internet through the Ethernet port and/or the wireless communication module of the signal I/O portion 128 or the IPTV set-top box.

If the signal I/O portion 128 outputs a digital signal, the digital signal may be input to and processed by the controller 160. While the digital signal may comply with various standards, the digital signal may be shown to be a stream signal TS as shown in FIG. 1. The stream signal TS may be a signal in which a video signal, an audio signal and/or a data signal are multiplexed. For example, the stream signal TS may be an MPEG-2 TS obtained by multiplexing an MPEG-2 video signal and a Dolby AC-3 audio signal.

The demodulator 130 may perform demodulation and channel decoding on the digital IF signal DIF received from the tuner 120, thereby obtaining a stream signal TS. The stream signal TS may be a signal in which a video signal, an audio signal and/or a data signal are multiplexed. For example, the first stream signal TS may be an MPEG-2 TS obtained by multiplexing an MPEG-2 video signal and a Dolby AC-3 audio signal. An MPEG-2 TS may include a 4-byte header and a 184-byte payload.

The stream signal TS may be input to the controller 160 and may thus be subjected to demultiplexing and signal processing. The stream signal TS may be input to a channel browsing processor (not shown) and may thus be subjected to a channel browsing operation prior to input to the controller 160.

In order to properly handle not only ATSC signals but also DVB signals, the demodulator 130 may include an ATSC demodulator and a DVB demodulator.

The interface 150 may transmit a signal received from the user to the controller 160 or transmit a signal received from the controller 160 to the user. For example, the interface 150 may receive various user input signals such as a power-on/off signal, a channel selection signal, and/or a screen setting signal from a remote controller 200 or may transmit a signal received from the controller 160 to the remote controller 200.

The controller 160 may demultiplex an input stream signal into a number of signals and process the demultiplexed signals so that the processed signals can be output as A/V data. The controller 160 may provide overall control to the image display apparatus 100.

The controller 160 may include a demultiplexer (not shown), a video processor (not shown), an audio processor (not shown), a data processor (not shown) and/or an On-Screen Display (OSD) processor (not shown).

The controller 160 may control the tuner 120 to tune to a user-selected channel and/or RF broadcasting of preliminarily memorized (or stored) channels.

The controller 160 may demultiplex an input stream signal (e.g. an MPEG-2 TS) into a video signal, an audio signal and a data signal.

The controller 160 may process the video signal. For example, if the video signal is an encoded signal, the controller 160 may decode the video signal. More specifically, if the video signal is an MPEG-2 encoded signal, the controller 160 may decode the video signal by MPEG-2 decoding. On the other hand, if the video signal is an H.264-encoded DMB or a DVB-handheld (DVB-H) signal, the controller 160 may decode the video signal by H.264 decoding.

In addition, the controller 160 may adjust brightness, tint and/or color of the video signal.

The video signal processed by the controller 160 may be displayed on the display 180. The video signal processed by the controller 160 may also be output to an external output port coupled to an external output device (not shown).

The controller 160 may process the audio signal obtained by demultiplexing the input stream signal. For example, if the audio signal is an encoded signal, the controller 160 may decode the audio signal. More specifically, if the audio signal is an MPEG-2 encoded signal, the controller 160 may decode the audio signal by MPEG-2 decoding. On the other hand, if the audio signal is an MPEG-4 Bit Sliced Arithmetic Coding (BSAC)-encoded terrestrial DMB signal, the controller 160 may decode the audio signal by MPEG-4 decoding. On the other hand, if the audio signal is an MPEG-2 Advanced Audio Coding (AAC)-encoded DMB or DVB-H signal, the controller 180 may decode the audio signal by Advanced Audio CODEC (AAC) decoding.

In addition, the controller 160 may adjust the base, treble and/or sound volume of the audio signal.

The audio signal processed by the controller 160 may be output to the audio output portion 185 (e.g., a speaker). Alternatively, the audio signal processed by the controller 160 may be output to an external output port coupled to an external output device.

The controller 160 may receive the analog baseband A/V signal, CVBS/SIF from the tuner 120 or the signal I/O portion 128 and process the received analog baseband A/V signal, CVBS/SIF. The processed video signal may be displayed on the display 180 and the processed audio signal may be output to the audio output portion 185 (for example, to a speaker) for voice output.

The controller 160 may process the data signal obtained by demultiplexing the input stream signal. For example, if the data signal is an encoded signal such as an Electronic Program Guide (EPG), which provides broadcast information (e.g. start time and end time) about programs played on each channel, the controller 160 may decode the data signal. Examples of an EPG include ATSC-Program and System Information Protocol (PSIP) information in case of ATSC and DVB-Service Information (SI) in case of DVB. The ATSC-PSIP information or DVB-SI information may be included in a header of a TS (i.e., a 4-byte header of an MPEG-2 TS).

The controller 160 may perform on-screen display (OSD) processing. More specifically, the controller 160 may generate an OSD signal for displaying various pieces of information on the display 180 such as graphic or text data based on a user input signal received from the remote controller 200 or at least one of a processed video signal or a processed data signal.

The OSD signal may include various data such as a User-Interface (UI) screen, various menu screens, widgets, and/or icons for the image display apparatus 100.

The memory 175 (or storage) may store various programs for processing and controlling signals by the controller 160, and may also store processed video, audio and data signals.

The memory 175 may temporarily store a video, audio and/or data signal received from the signal I/O portion 128.

The memory 175 may include, for example, at least one of a flash memory-type storage medium, a hard disc-type storage medium, a multimedia card micro-type storage medium, a card-type memory, a Random Access Memory (RAM) and/or a Read-Only Memory (ROM) such as an Electrically Erasable Programmable ROM (EEPROM).

The image display apparatus 100 may play a file (such as a moving picture file, a still image file, a music file, or a text file) stored in the memory 175 to the user.

The display 180 may convert a processed video signal, a processed data signal, and/or an OSD signal received from the controller 160 or a video signal and a data signal received from the signal I/O portion 128 to RGB signals, thereby generating driving signals.

The display 180 may be one of various types of displays such as a Plasma Display Panel (PDP), a Liquid Crystal Display (LCD), an Organic Light-Emitting Diode (OLED), a flexible display, and/or a three-dimensional (3D) display.

The display 180 may be implemented as a touch screen so that it is used not only as an output device but also as an input device. The user may enter data and/or a command directly on the touch screen. When the user touches a specific object displayed on the touch screen with his hand or a tool such as a stylus pen, the touch screen may output a touch signal corresponding to the touch to the controller 160 so that the controller 160 performs an operation corresponding to the touch signal. A touch input may be made with tools other than the fingertip or the stylus pen.

There may be many types of touch screens including a capacitive touch screen and a resistive touch screen, although embodiments of the present invention are not limited.

The sensor portion 140 may include a proximity sensor, a touch sensor, a voice sensor, a location sensor, and/or an operation sensor, for example.

The proximity sensor may sense an approaching object and/or presence or absence of a nearby object without any physical contact. The proximity sensor may use a variation in a magnetic alternating field, an electromagnetic field, and/or electrostatic capacitance, when sensing a nearby object.

The touch sensor may be the touch screen of the display 180. The touch sensor may sense a user-touched position or strength on the touch screen. The voice sensor can sense the user's voice or a variety of sounds created by the user. The location sensor may sense the user's location. The operation sensor may sense the user's gestures or movements. The location sensor or the operation sensor may be configured as an IR sensor or a camera and may sense a distance between the image display apparatus 100 and the user, the presence or absence of a user's motion, the user's hand motions, a height of the user, and/or an eye height of the user.

The above-described sensors may output a result of sensing the voice, touch, location and/or motion of the user to a sensing signal processor (not shown), and/or the sensors may primarily interpret the sensed results, generate sensing signals corresponding to the interpretations, and/or output the sensing signals to the controller 160.

In addition to the above sensors, the sensor portion 140 may include other types of sensors for a distance between the image display apparatus 100 and the user, the presence or absence of a user's motion, the user's hand motions, the height of the user, and/or the eye height of the user.

The audio output portion 185 may receive a processed audio signal (e.g. a stereo signal, a 3.1-channel signal and/or a 5.1-channel signal) from the controller 160 and output the received audio signal as voice. The audio output portion 185 may be implemented into various types of speakers.

The remote controller 200 may transmit a user input to the interface 150. For transmission of a user input, the remote controller 200 may use various communication techniques such as Bluetooth, RF, IR, Ultra Wideband (UWB) and/or ZigBee.

The remote controller 200 may also receive a video signal, an audio signal and/or a data signal from the interface 150 and output the received signals.

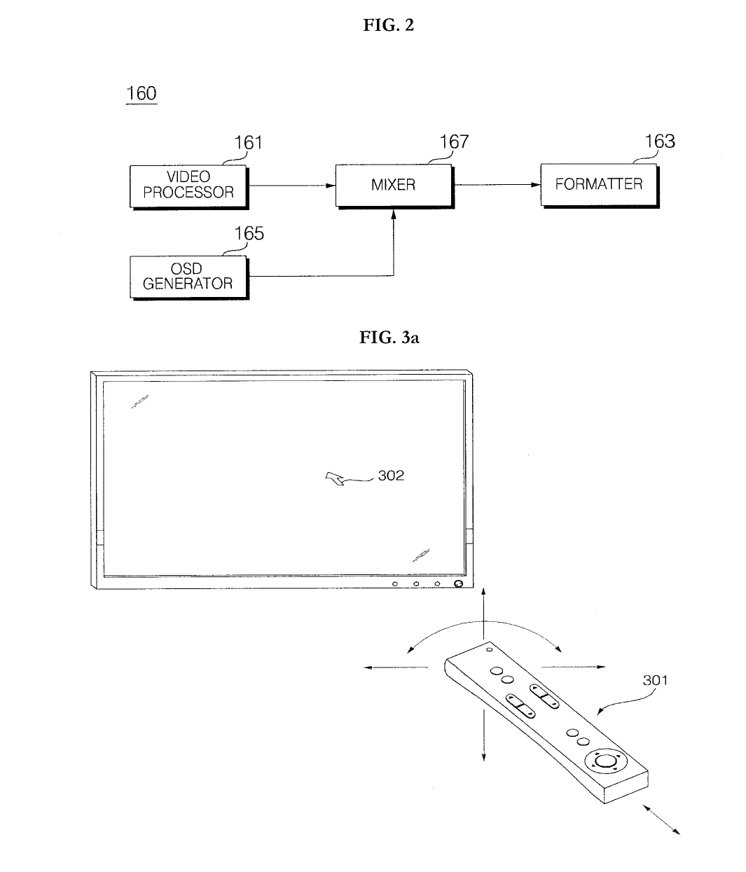

FIG. 2 is a block diagram of the controller 160 illustrated in FIG. 1.

As shown in FIG. 2, the controller 160 may include a video processor 161 (or image processor) and a formatter 163.

The video processor 161 may process a video signal included in a broadcast signal that has been processed in the tuner 110 and the demodulator 120 and/or an external input signal received through the signal I/O portion 128. The video signal input to the video processor 161 may be obtained by demultiplexing a stream signal.

If the demultiplexed video signal is, for example, an MPEG-C part depth video signal, the video signal may be decoded by an MPEG-C decoder. Disparity information may also be decoded.

The video signal decoded by the video processor 161 may be a three-dimensional (3D) video signal of various formats. For example, the 3D video signal may include a color image and a depth image, and/or multi-viewpoint image signals. The multi-viewpoint video signals may include left-eye and right-eye video signals, for example.

3D formats may include a side-by-side format, a top/down format, a frame sequential format, an interlaced format, and/or a checker box format. The left-eye and right-eye video signals may be arranged on left and right sides, respectively, in the side-by-side format. The top/down format may have the left-eye and right-eye video signals up and down, respectively. The left-eye and right-eye video signals may be arranged in time division in the frame sequential format. If the left-eye and right-eye video signals alternate with each other on a line-by-line basis, and this format is called an interlaced format. In the checker box format, the left-eye and right-eye video signals may be mixed in the form of boxes.

The formatter 163 may separate the decoded video signal into a 2D video signal and a 3D video signal and may further divide the 3D video signal into multi-viewpoint video signals, for example, left-eye and right-eye video signals.

The controller 160 may further include an on-screen display (OSD) generator 165 and a mixer 167.

The OSD generator 165 may receive a video signal related to caption or data broadcasting and output an OSD signal related to the caption or data broadcasting. The mixer 167 may mix the decoded video signal with the OSD signal. The formatter 163 may generate a 3D video signal including various OSD data based on the mixed signal received from the mixer 167.

The controller 160 may be configured as shown in FIG. 2 according to an exemplary embodiment. Some of the components of the controller 160 may be incorporated or omitted, and/or components may be added to the controller 160 according to the specification of the controller 160 in real implementation. More specifically, two or more components of the controller 160 may be incorporated into a single component, and/or a single component of the controller 160 may be separately configured. In addition, a function of each component may be provided for illustrative purposes and its specific operation and configuration may not limit the scope and spirit of embodiments.

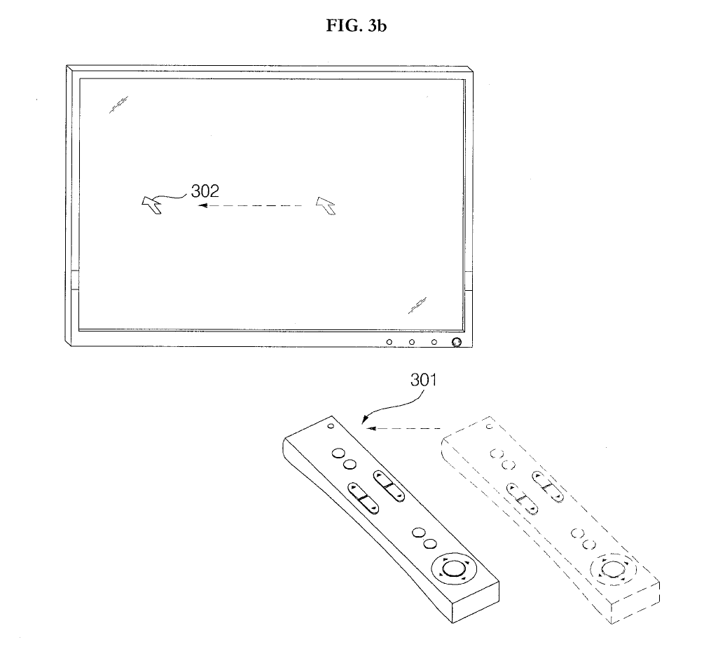

FIGS. 3a and 3b illustrate examples of the remote controller 200 illustrated in FIG. 1.

As shown in FIGS. 3a and 3b, the remote controller 200 may be a pointing device 301.

The pointing device 301 may be for entering a command to the image display apparatus 100. The pointing device 301 may transmit and/or receive RF signals to or from the image display apparatus 100 according to an RF communication standard. As shown in FIG. 3a, a pointer 302 representing movement of the pointing device 301 may be displayed on the image display apparatus 100.

The user may move the pointing device 301 up and down, back and forth, and side to side and/or may rotate the pointing device 301. The pointer 302 may move in accordance with movement of the pointing device 301, as shown in FIG. 3b.

If the user moves the pointing device 301 to the left, the pointer 302 may move to the left accordingly. The pointing device 301 may include a sensor capable of detecting motions. The sensor of the pointing device 301 may detect the movement of the pointing device 301 and transmit motion information corresponding to a result of the detection to the image display apparatus 100. The image display apparatus 100 may determine the movement of the pointing device 301 based on the motion information received from the pointing device 301, and calculate coordinates of a target point to which the pointer 302 should be shifted in accordance with the movement of the pointing device 301 based on the result of the determination.

The pointer 302 may move according to a vertical movement, a horizontal movement and/or a rotation of the pointing device 301. A moving speed and direction of the pointer 302 may correspond to a moving speed and direction of the pointing device 301.

The pointer 302 may move in accordance with the movement of the pointing device 301. Alternatively, an operation command may be input to the image display apparatus 100 in response to the movement of the pointing device 301. That is, as the pointing device 301 moves back and forth, an image displayed on the image display apparatus 100 may be gradually enlarged or reduced. This exemplary embodiment does not limit the scope and spirit of embodiments of the present invention.

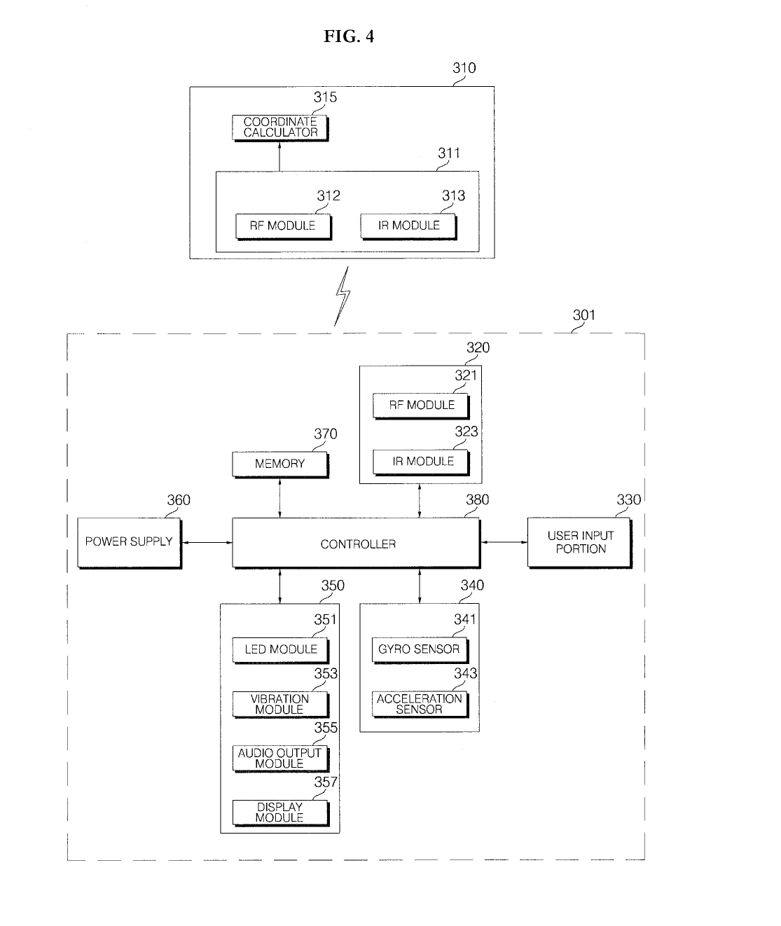

FIG. 4 is a block diagram of the pointing device 301 illustrated in FIGS. 3a and 3b and the interface 150 illustrated in FIG. 1. As shown in FIG. 4, the pointing device 301 may include a wireless communication module 320, a user input portion 330, a sensor portion 340, an output portion 350, a power supply 360, a memory 370 (or storage), and a controller 380.

The wireless communication module 320 may transmit signals to and/or receive signals from the image display apparatus 100. The wireless communication module 320 may include an RF module 321 for transmitting RF signals to and/or receiving RF signals from the interface 150 of the image display apparatus 100 according to an RF communication standard. The wireless communication module 320 may also include an infrared (IR) module 323 for transmitting IR signals to and/or receiving IR signals from the interface 150 of the image display apparatus 100 according to an IR communication standard.

The pointing device 301 may transmit motion information regarding the movement of the pointing device 301 to the image display apparatus 100 through the RF module 321. The pointing device 301 may also receive signals from the image display apparatus 100 through the RF module 321. The pointing device 301 may transmit commands to the image display apparatus 100 through the IR module 323, when needed, such as a power on/off command, a channel switching command, and/or a sound volume change command.

The user input portion 330 may include a keypad and/or a plurality of buttons. The user may enter commands to the image display apparatus 100 by manipulating the user input portion 330. If the user input portion 330 includes a plurality of hard-key buttons, the user may input various commands to the image display apparatus 100 by pressing the hard-key buttons. If the user input portion 330 includes a touch screen displaying a plurality of soft keys, the user may input various commands to the image display apparatus 100 by touching the soft keys. The user input portion 330 may also include various input tools other than those set forth herein, such as a scroll key and/or a jog key, which should not limit embodiments of the present invention.

The sensor portion 340 may include a gyro sensor 341 and/or an acceleration sensor 343. The gyro sensor 341 may sense the movement of the pointing device 301, for example, in X-, Y-, and Z-axis directions, and the acceleration sensor 343 may sense the moving speed of the pointing device 301. The output portion 350 may output a video and/or audio signal corresponding to a manipulation of the user input portion 330 and/or a signal transmitted by the image display apparatus 100. The user may easily identify whether the user input portion 330 has been manipulated or whether the image display apparatus 100 has been controlled based on the video and/or audio signal output by the output portion 350.

The output portion 350 may include a Light Emitting Diode (LED) module that is turned on or off whenever the user input portion 330 is manipulated or whenever a signal is received from or transmitted to the image display apparatus 100 through the wireless communication module 320, a vibration module 353 that generates vibrations, an audio output module 355 that outputs audio data, and a display module 357 that outputs video data.

The power supply 360 may supply power to the pointing device 301. If the pointing device 301 is kept stationary for a predetermined time or longer, the power supply 360 may reduce or cut off supply of power to the pointing device 301 in order to save power, for example. The power supply 360 may resume the power supply when a specific key on the pointing device 301 is manipulated.

The memory 370 may store various application data for controlling or driving the pointing device 301. The pointing device 301 may wirelessly transmit signals to and/or receive signals from the image display apparatus 100 in a predetermined frequency band with the aid of the RF module 321. The controller 380 of the pointing device 301 may store information regarding the frequency band used for the pointing device 301 to wirelessly transmit signals to and/or wirelessly receive signals from the paired image display apparatus 100 in the memory 370 and may then refer to this information for a later use.

The controller 380 may provide overall control to the pointing device 301. For example, the controller 380 may transmit a signal corresponding to a key manipulation detected from the user input portion 330 or a signal corresponding to a motion of the pointing device 301, as sensed by the sensor portion 340, to the interface 150 of the image display apparatus 100.

The interface 150 may include a wireless communication module 311 that wirelessly transmits signals to and/or wirelessly receives signals from the pointing device 301, and a coordinate calculator 315 that calculates a pair of coordinates representing a position of the pointer 302 on the display screen to which the pointer 302 is to be moved in accordance with movement of the pointing device 301.

The wireless communication module 311 may include an RF module 312 and an IR module 313. The RF module 312 may wirelessly transmit RF signals to and/or wirelessly receive RF signals from the RF module 321 of the pointing device 301. The IR module 313 may wirelessly transmit IR signals to and/or wirelessly receive IR signals from the IR module 321 of the pointing device 301.

The coordinate calculator 315 may receive motion information regarding the movement of the pointing device 301 from the wireless communication module 320 of the pointing device 301 and may calculate a pair of coordinates (x, y) representing the position of the pointer 302 on a screen of the display 180 by correcting the motion information for a user's handshake or possible errors.

A signal received in the image display apparatus 100 from the pointing device 301 through the interface 150 may be transmitted to the controller 160. The controller 160 may acquire information regarding the movement of the pointing device 301 and information regarding a key manipulation detected from the pointing device 301 from the signal received from the interface 150, and may control the image display apparatus 100 based on the acquired information.

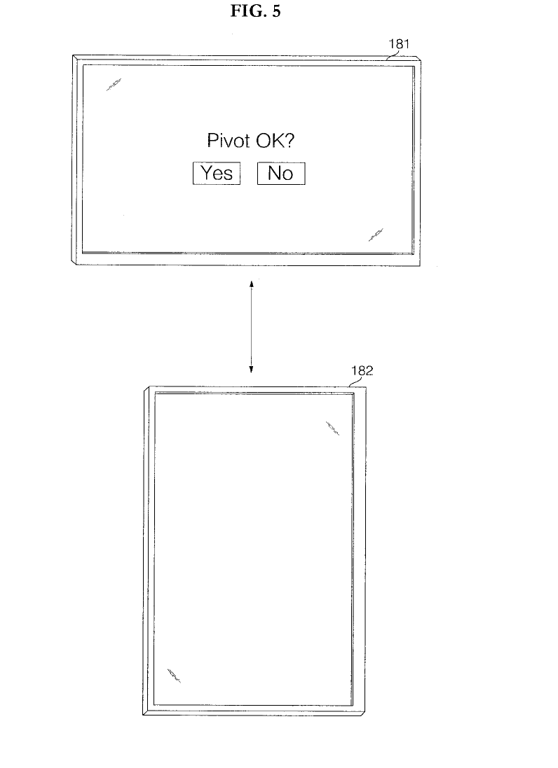

FIG. 5 is a view illustrating an example of pivoting the image display apparatus.

The image display apparatus 100 may be pivoted in a clockwise direction and/or a counterclockwise direction, for example. The image display apparatus 100 may also be pivoted at 90 degrees and/or at any other predetermined angle. Pivoting may refer to rotation of the image display apparatus 100 using a specific point and/or a virtual line as a reference point or an axis.

If the image display apparatus 100 is a stand type support member or a wall type support member, the image display apparatus 100 may be pivoted by a rotation device included in a support member. The user may pivot the image display apparatus 100 manually by using a rotation device. The image display apparatus 100 may also include a motor and upon receipt of a pivot command, the controller 160 may automatically pivot the image display apparatus 100 by driving the motor. Other pivot devices may also be used.

In an example embodiment, two modes may be available to the image display apparatus 100, namely a latitudinal mode (or pivot release mode) and a longitudinal mode (or pivot setting mode). In the latitudinal mode (or pivot release mode), the display 180 may take a latitudinal form 181 having a width larger than a length, whereas in the longitudinal mode (or pivot setting mode), the display 180 may take a longitudinal form 182 having a length larger than a width, resulting from 90-degree rotation in the latitudinal mode.

The controller 160 may control an image displayed on the display 180 to be pivoted in accordance with the pivoting motion of the image display apparatus 100.

As shown in FIG. 5, a menu prompting the user to select at least one of pivot setting (“Yes”) or pivot release (“No”) may be displayed. When the user selects pivot setting, the display 180 may pivot from the latitudinal form 181 to the longitudinal form 182. If the user selects pivot release, the display 180 may rotate so that it returns from the longitudinal form 182 to the latitudinal form 181.

Other pivot setting modes may be provided for pivoting the image display apparatus 100 at various angles.

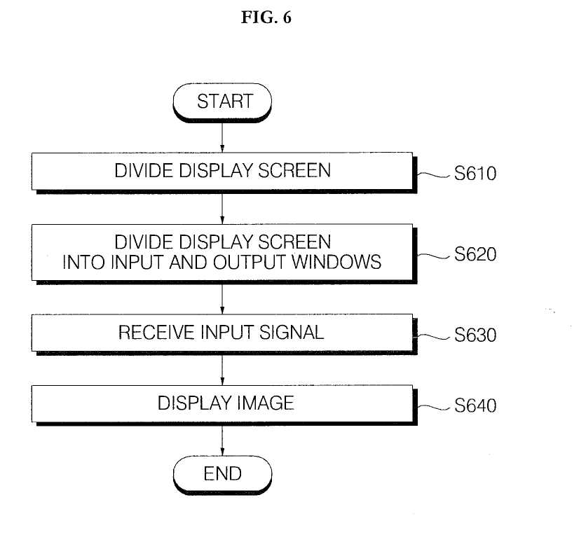

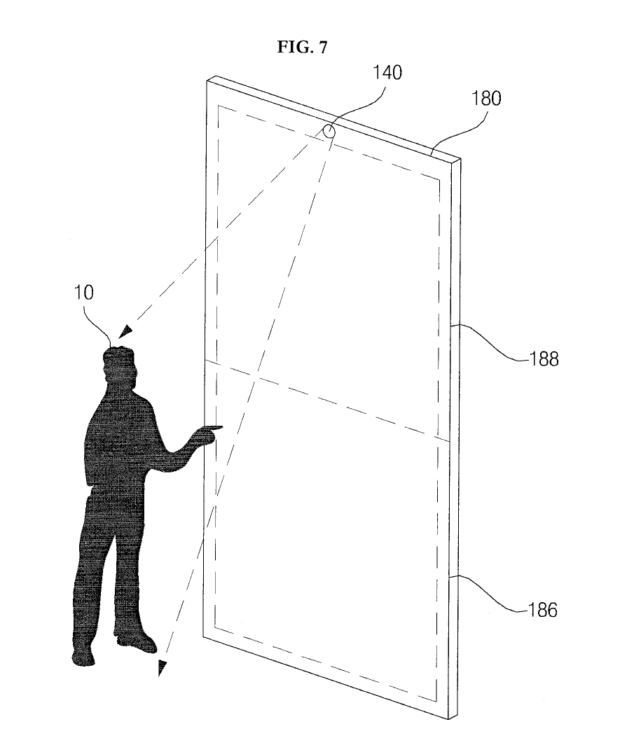

FIG. 6 is a flowchart illustrating a method for operating the image display apparatus according to an exemplary embodiment of the present invention. FIGS. 7 to 12 are views relating to describing the method for operating the image display apparatus as shown in FIG. 6. Other embodiments, configurations, operations and orders of operations are also within the scope of the present invention.

As shown in FIG. 6, the operation method for the image display apparatus 100 may include sensing the height or the eye height of the user (S610), dividing the screen of the display 180 into an input window and an output window (S620), receiving an input signal (or input) through the input window (S630), and displaying an image on the output window (S640). The displayed image may correspond to a trajectory of the input signal (or input) on the input window.

The sensor portion 140 may sense the height or the eye height of the user in operation S610, as shown in FIG. 7. Although the sensor portion 140 is positioned in an upper part of the display 180 taking the longitudinal form 182 elongated vertically as shown in FIG. 7, the sensor portion 140 may reside in another area of the display 180. The sensor portion 140 may be configured in various manners by making a choice as to the sensor portion 140 in terms of number, position, and/or sensor type, depending on a used location sensing algorithm or for the purpose of increasing accuracy.

If a user 10 stands, a screen optimal to the height of the user 10 may be displayed. However, if the user 10 sits down or lies on his back, a screen optimal to the eye height of the user 10 may be displayed.

A menu prompting the user 10 to select at least one of pivot setting or pivot release of the image display apparatus 100 may be further displayed.

If a content or an image is suitable for the vertically elongated longitudinal form 182 of the display 180, if a short height is sensed, if a pivot command is received from the user, and/or if it is determined from a short eye height of the user that the user is short or does not stand, the menu may relate to determining from the user whether to pivot the image display apparatus 100 and prompt the user to select between pivot setting and pivot release.

Upon user selection of pivot setting, the image display apparatus 100 may be pivoted to a state where the image display apparatus 100 is vertically elongated.

In operation S620, the controller 160 divides the screen of the display 180 into an input window 186 from which to receive an input signal (or input) and an output window 188 for displaying a feedback image, corresponding to the sensed height or the sensed eye height of the user.

As shown in FIG. 7, the controller 160 may divide the screen of the display 180 such that the output window 188 is positioned over (or above) the input window 186. For example, if the image display apparatus 100 hangs considerably high on a wall or if the display 180 takes the longitudinal form 182 so that the display 180 is elongated vertically, the screen of the display 180 may be divided that the input window 186 is positioned in a lower part of the screen, to thereby facilitate the user to touch the display 180. Especially for a small child, the input window 186 may be defined to correspond to the height of the kid. Therefore, the child may actively make touch inputs and enjoy more contents.

A main image as received on a user-selected broadcast channel as well as a feedback image corresponding to an input to the input window 186 may be displayed on the output window 188. Short keys, a menu, etc. for invoking specific functions may be displayed in a certain area of the input window 186. Thus, an intended function may be executed fast without disturbing viewing of the main image.

The controller 160 may change at least one of the input window 186 or the output window 188 in a position, a number, and/or an area corresponding to the sensed height or the sensed eye height of the user.

Since the input window 186 and the output window 188 are separately displayed in this manner, the user may easily identify and use an area available for input.

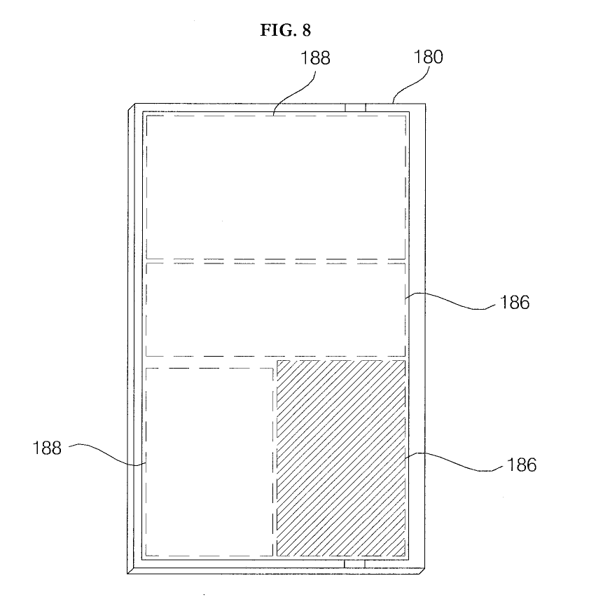

As shown in FIG. 8, the screen of the display 180 may be divided into two input windows 186 and two output windows 188. When the existence of a plurality of users is sensed or determined, the screen of the display 180 may be divided into a plurality of input windows (or input window areas) and a plurality of output windows (or output window areas). Depending on the sensed height or the sensed eye height of the user, the screen of the display 180 may be divided in many ways.

The number of users may be different from the number of input windows (or input window areas) and/or the number of output windows (or output window areas), and/or both. For example, feedback images corresponding to signals input to two input windows may be output on a single output window.

As one example, a display method may include sensing or determining a number of users of the image display apparatus, dividing an input window of the image display apparatus into a plurality of input areas (or input windows) based on the sensed or determined number of users, and dividing an output window of the image display apparatus into a plurality of output areas (or output windows) based on the sensed or determined number of users. A first input may be received to correspond to a first one of the input areas of the input window, and a second input may be received to correspond to a second one of the input areas of the input window. A first image, corresponding to the received first input, may be displayed on the first one of the output areas of the output window. A second image, corresponding to the received second input, may be displayed on the second one of the output areas of the output window.

As one example, a menu may be displayed relating to a number of input window (or input window areas) and/or a number of output window (or output window areas). Information regarding a desired number of input window areas or a desired number of output window areas may be received by the image display apparatus. The desired number of input windows (or input window areas) or the desired number of output windows (ow output window areas) may be displayed on the image display apparatus (and/or remote controller).

At least one of the input windows 186 or the output windows 188 may be different in color. For example, the input window 186 may be displayed in white, thus giving a sense of a whiteboard to the user.

An input signal may be received through the input window in operation S630 and an image corresponding to a trajectory of the input signal may be displayed on the output window in operation S640.

As described above with reference to FIG. 1, the display 180 may be configured as a touch screen and thus an input signal of the input window may a touch signal input on the touch screen. The touch signal may be generated by a touch input made by a tool such as a stylus pen as well as a user's hand or finger, for example. The touch input may include touching a point and then dragging to another point.

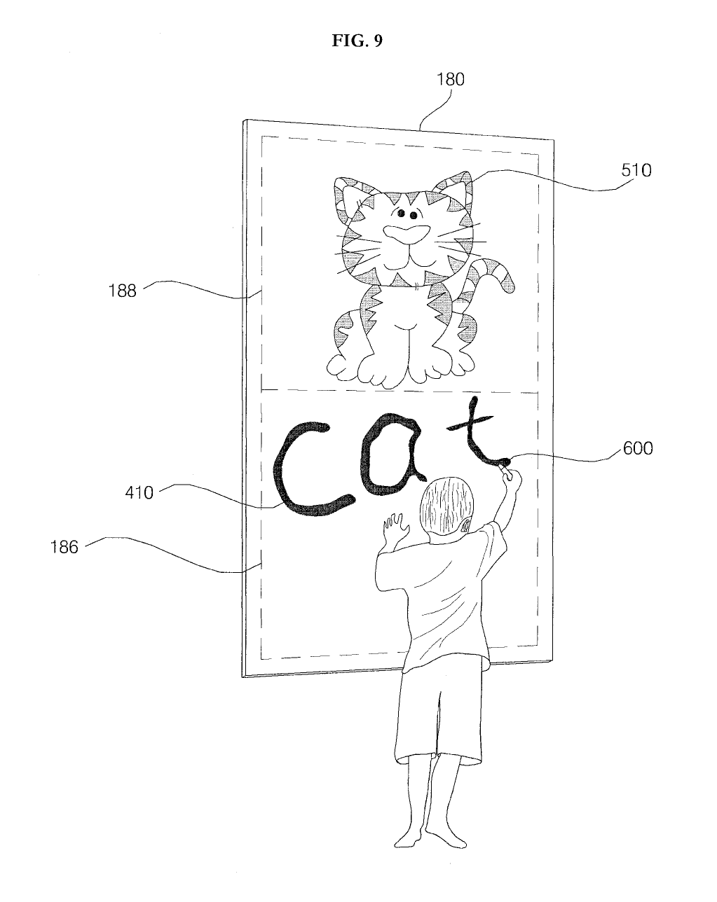

FIG. 9 illustrates input of a sequence of characters ‘cat’ on the input window 186 by a touch signal. For example, a user having a cat named Dexter may desire to write “Dexter” or “cat” on the image display apparatus.

As shown in FIG. 9, a trajectory of an input signal may be displayed on the input window 186. Thus, the user can identify whether he is making his intended input. The trajectory of the input signal may last on the input window 186 until the input is completed and/or for a predetermined time period.

The trajectory of the input signal may refer to a trace or a shape that begins with an input start and ends with an input end, including starting an input and ending the input at a same position. A touch input at a point may be represented as a spot of a predetermined size.

The controller 160 may control an image corresponding to the trajectory of the input signal on the input window 186 to be displayed on the output window 188 of the display 180.

If the trajectory of the input signal matches at least one character, an image corresponding to the character may be displayed on the output window 188. In an exemplary embodiment, when the trajectory of an input signal generated by a touch of a user's hand or a tool 600 matches a sequence of characters “cat”, a cat image may be displayed on the output window 188 as shown in FIG. 9. That is, when three alphabetical characters are input and thus a meaningful word “cat” is completed on the input window 186, a cat (named Dexter) may be displayed on the output window 188. The term “character” may be any one of a digit, a capital or lower-case alphabet, a Korean character, a special symbol, etc. in its meaning.

The image displayed on the output window 188 may be a still image and/or a moving picture. A still image or moving picture of a cat may be displayed on the output window 188.

The audio output portion 185 may emit a sound associated with the image displayed on the output window 188. For example, a cat's meowing may sound.

The image display apparatus 100 may further include a scent diffuser (not shown) containing at least one scent. The scent diffuser may diffuse a scent with aroma such as rose or lavender through a nozzle (not shown), and/or may create a fragrance associated with an image displayed on the output window 188 by diffusing one or more scents.

A gesture may be made as an input to the input window. As described above with reference to FIG. 1, the sensor portion 140 may further receive a gesture input signal of the user.

The image display apparatus 100 may further include a second sensor (or second sensor portion). The second sensor portion may sense a user's gesture faster and more accurately because the second sensor portion is dedicated to reception of gesture input signals. The sensor portion 140 may be configured with sensors for sensing keys, etc., thus enabling various sensor combinations and increasing design freedom.

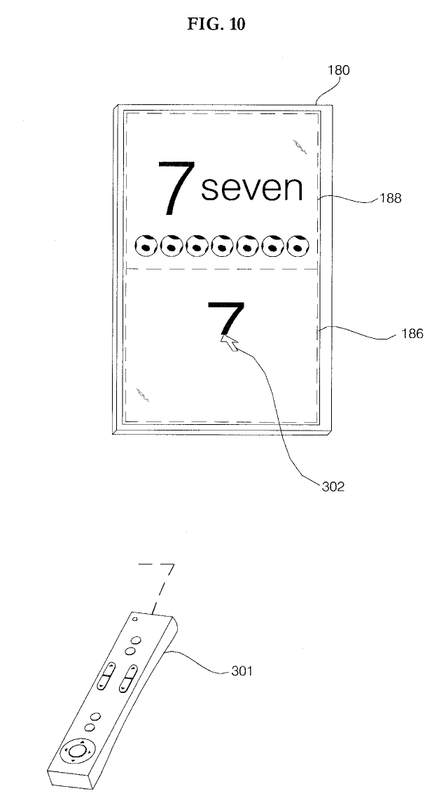

A pointing signal transmitted by the pointing device 301 may be input to the input window. The pointing signal may be received through the interface 150. FIG. 10 shows a screen having an input made by the user with the pointing device 301 according to an exemplary embodiment.

The pointer 302 may be displayed on the display 180 according to the pointing signal corresponding to a movement of the pointing device 301. If the pointing device 301 draws a digit “7”, the pointer 302 may move in the form of “7” accordingly on the input window 186. The trajectory of the input signal may be displayed on the input window 186.

An image corresponding to the trajectory of the input signal, that is, the digit “7” may be displayed on the output window 188. If the input signal is recognized as a character or characters, the character or characters may be displayed on the output window 188 as shown in FIG. 10.

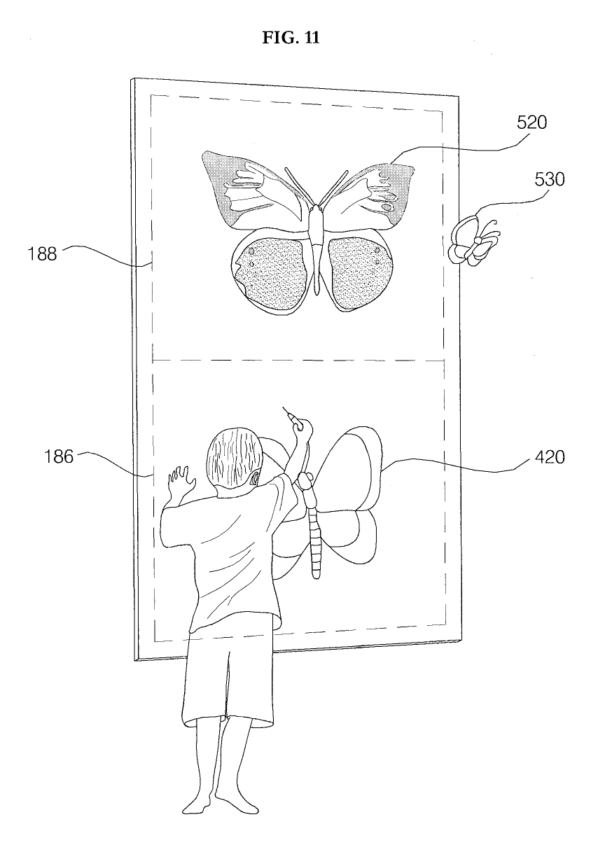

As shown in FIG. 11, a guideline or guide image 420 may be displayed on the input window 186 so that the user draws or makes an input along the guideline or guide image 420.

The user may draw or make an input referring to the guideline or guide image 420. As a butterfly-like form is input along the guide image 420 to the input window 186, a butterfly image 520 corresponding to the input signal may be displayed on the output window 188.

The image corresponding to the input signal may be a still image or a moving picture. The still image or moving picture may be displayed with the illusion of being three-dimensional (3D). That is, a 3D image 530 may be displayed, appearing as a flying butterfly or as a butterfly protruding toward the user.

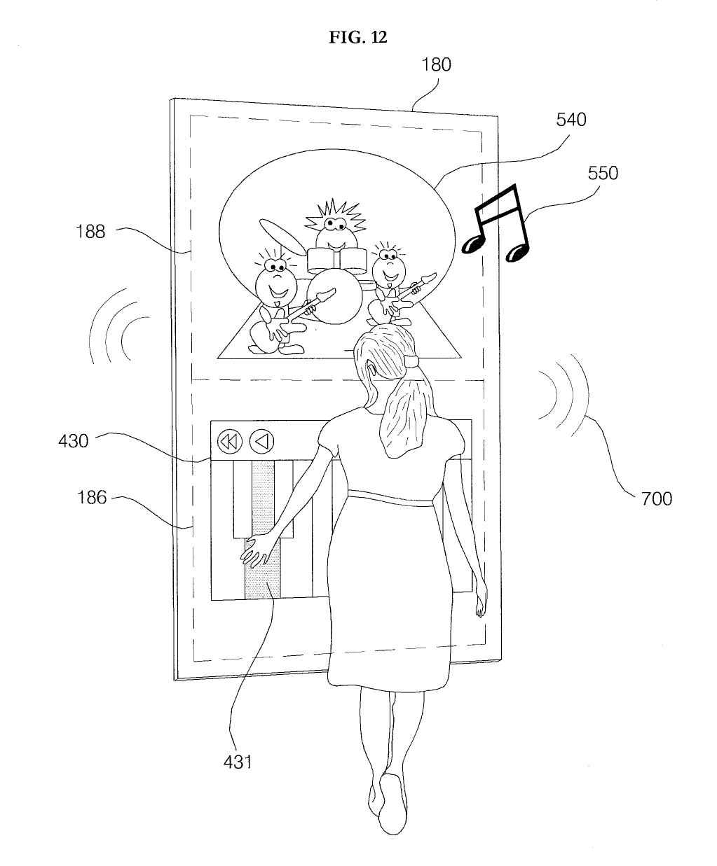

As shown in FIG. 12, an object 430 for performing a specific operation or function may be displayed in a certain area of the input window 186. If a specific area of the object 430 is touched, dragged and/or pointed on the input window 186 and thus a selection input signal is generated, an image corresponding to the trajectory of the input signal may be displayed on the output window 188.

In the example shown in FIG. 12, the user may select a specific area 431 representing a key in the keyboard-shaped object 430, thus generating an input signal, a note sound- or music-related image 540 corresponding to the selected area 431 may then be displayed on the output window 188.

The image 540 may be a still image or a moving picture. For example, a still image or moving picture of a music band that is playing music may be displayed on the output window 188 as shown in FIG. 12. The audio output portion 185 may also emit a related sound 700.

A 3D image 550 may also be displayed on the output window 188 by looking protruding to the user. The depth and size of the 3D image 550 may change when displayed. If the 3D image 550 has a changed depth, it may appear protruding to a different degree.

More specifically, the video processor 161 may process an input video signal based on a data signal and the formatter 163 may generate a graphic object for a 3D image from the processed video signal. The depth of the 3D object may be set to be different from the display 180 or an image displayed on the display 180.

The controller 160, and more particularly the formatter 163, may perform signal processing such that at least one of the displayed size or depth of the 3D object is changed and also a deeper 3D object may have a narrower disparity between the left-eye and right-eye of the 3D object.

As described above, the screen of a display may be divided into an input window and an output window corresponding to the height or the eye height of a user. The input window may receive an input (or input signal) in various manners and the output window may display a feedback image.

An optimal screen layout and screen division may be provided according to characteristics of contents and/or a user's taste. Because a variety of contents including education contents, games, etc. are provided as images optimized to the height or the eye height of the user and a feedback image is displayed in correspondence with a user input, the user may enjoy contents with an increased interest in various ways. Therefore, user convenience may be enhanced.

The operation method of the image display apparatus may be implemented as a code that can be written on a computer-readable recording medium and can thus be read by a processor. The computer-readable recording medium may be any type of recording device in which data is stored in a computer-readable manner.

Examples of the computer-readable recording medium may include a ROM, a RAM, a CD-ROM, a magnetic tape, a floppy disc, an optical data storage, and/or a carrier wave (e.g., data transmission through the internet). The computer-readable recording medium may be distributed over a plurality of computer systems coupled to a network so that computer-readable code is written thereto and executed therefrom in a decentralized manner. Functional programs, code, and/or code segments needed for realizing embodiments herein may be construed by one of ordinary skill in the art.

According to one or more of the aforementioned exemplary embodiments, screen layout and screen division may be optimized according to characteristics of contents or a user's taste. An image may also be optimized to the height or the posture of the user and a feedback image corresponding to a user's input may be displayed. In addition, various inputs and outputs may be available by dividing a screen according to the type of contents and the height or the posture of the user, and the user may be allowed to use contents easily. Therefore, the user may enjoy contents with an increased convenience.

One or more embodiments as described herein may provide an image display apparatus and an operation method therefor that can increase user convenience by optimizing screen layout and screen division.

According to one aspect, a method may be provided for operating an image display apparatus, including sensing a height or an eye height of a user, dividing a screen of a display into an input window and an output window corresponding to the sensed height or the sensed eye height of the user, receiving an input (or input signal) on the input window, and displaying an image corresponding to a trajectory of the input signal on the output window.

An image display apparatus may include a display for displaying an image, a sensor portion for sensing a height or an eye height of a user, and a sensor for controlling a screen of a display to be divided into an input window and an output window corresponding to the sensed height or the sensed eye height of the user. The controller may control an image corresponding to a trajectory of an input signal (or input) on the input window to be displayed on the output window.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for an image display apparatus, comprising:
sensing a height or a eye height of a user;
dividing a screen of a display into an input window and an output window based on the sensed height or the sensed eye height of the user;
receiving an input to correspond to the input window; and
displaying an image on the output window, the displayed image to correspond to the received input.

2. The method of claim 1, wherein receiving the input includes receiving a moving input, and displaying the image include displaying the image corresponding to the received moving input.

3. The method of claim 1, further comprising displaying a menu relating to a number of input window areas or a number of output window areas.

4. The method of claim 1, further comprising:
receiving information regarding a desired number of input window areas or a desired number of output window areas; and
displaying the desired number of input window areas or the desired number of output window areas.

5. The method of claim 1, wherein dividing the screen of the display comprises changing at least one of the input window or the output window in at least one of a position, a number or an area, corresponding to the sensed height or the sensed eye height of the user.

6. The method of claim 1, wherein dividing the screen comprises dividing the screen of the display horizontally so that the output window is above the input window.

7. The method of claim 1, further comprising:
displaying a menu prompting a user to select at least one of a pivot setting or a pivot release for the image display apparatus; and
upon selecting of the pivot setting, pivoting the image display apparatus to be elongated vertically so the image display apparatus has a length larger than a width.

8. The method of claim 1, wherein dividing the screen of the display comprises dividing the screen of the display into the input window and the output window so the input window and the output window are different in at least one of color, area, or brightness.

9. The method of claim 1, wherein the input is at least one of a touch, a proximity touch, a gesture signal, or a pointing signal from a remote controller.

10. The method of claim 1, further comprising displaying a trajectory of the received input on the input window.

11. The method of claim 10, wherein when the trajectory of the received input matches at least one character, displaying the image includes displaying an image corresponding to the at least one character on the output window.

12. The method of claim 1, further comprising outputting a sound or a scent related to the image displayed on the output window.

13. The method of claim 1, wherein the image displayed on the output window is a three-dimensional (3D) image.

14. The method of claim 1, further comprising displaying an image on the input window, and receiving the input includes receiving an input that corresponds to a specific part of the image displayed on the input window.

15. A display method for an image display apparatus, comprising:
determining a number of users of the image display apparatus;
dividing an input window of the image display apparatus into a plurality of input areas based on the determined number of users;
dividing an output window of the image display apparatus into a plurality of output areas based on the determined number of users;
receiving a first input to correspond to a first one of the input areas of the input window;
receiving a second input to correspond to a second one of the input areas of the input window;
displaying a first image on a first one of the output areas of the output window, the displayed first image to correspond to the received first input; and
displaying a second image on a second one of the output areas of the output window, the displayed second image to correspond to the received second input.

16. The method of claim 15, wherein determining the number of users comprises sensing a number of users of the image display apparatus.

17. The method of claim 15, wherein determining the number of users comprises receiving information regarding a desired number of input window areas or a desired number of output window areas.

18. A method for an image display apparatus, comprising:
displaying a menu relating to a number of input window areas or a number of output window areas;
receiving information regarding a desired number of input window areas or a desired number of output window areas;
dividing the input window or the output window based on the received information;
receiving a first input to correspond to a first input area of the input window; and
displaying an image on a first output area of the output window, the displayed image to correspond to the received first input.

19. The method of claim 18, further comprising receiving a second input to correspond to a second input area of the input window.

20. The method of claim 19, further comprising displaying an image on a second output area of the output window, the displayed image to correspond to the received second input.
